(19) United States
(12) Patent Application Publication
(10) Pub. No.: US 2025/0083357 A1
(43) Pub. Date: Mar. 13, 2025

(54) SPRAYER FOR SQUARING CRYSTAL ROD AND CRYSTAL ROD SQUARING DEVICE

(71) Applicant: TCL ZHONGHUAN RENEWABLE ENERGY TECHNOLOGY CO., LTD., Tianjin (CN)

(72) Inventors: Xiaopeng WANG, Tianjin (CN); Zhihui LIANG, Tianjin (CN)

(73) Assignee: TCL ZHONGHUAN RENEWABLE ENERGY TECHNOLOGY CO., LTD., Tianjin (CN)

(21) Appl. No.: 18/552,912

(22) PCT Filed: Jun. 26, 2023
(86) PCT No.: PCT/CN2023/102485

§ 371 Date: Sep. 28, 2023

(30) Foreign Application Priority Data
Jun. 27, 2022 (CN) 202221617629.7

(51) Int. Cl. B28D 5/00; B28D 5/04

(52) U.S. Cl. CPC B28D 5/0076; B28D 5/045

(57) ABSTRACT

A sprayer for squaring crystal rod includes a first sprayer for wire guide wheel cleaning and a second sprayer for cutting, the first sprayer for wire guide wheel cleaning is disposed at a side of the wire guide wheel, and a liquid spray direction of the first sprayer for wire guide wheel cleaning corresponds to a wire guide groove of the wire guide wheel, so as to flush foreign matters in the wire guide groove in a process of squaring crystal rod; the second sprayer for cutting is disposed at a side of the crystal rod, and the second sprayer for cutting corresponds to a slit in the process of squaring crystal rod, and sprays the slit to discharge powder.

### CROSS-REFERENCE TO RELATED APPLICATION

This application claims priority to and the benefit of Chinese Patent Application No. 202221617629.7, filed in the China National Intellectual Property Administration on Jun. 27, 2022, the disclosure of which is hereby incorporated by reference in its entirety.

### TECHNICAL FIELD

The present disclosure relates to monocrystalline silicon rod processing, and in particular to a sprayer for squaring crystal rod (or silicon ingot) and a crystal rod squaring device.

### BACKGROUND

In a processing of a monocrystalline square rod, an existing sprayer (used to cool a processed square rod and discharge powder) used in a squaring of crystal rod has a higher spray position, although the spraying area is large, the powder discharging may not be performed effectively, water flow is small, and scouring force is insufficient, so that it is easy to cause wire break due to high temperature at a cutting position, the poor powder discharging cause a large cutting gradient and a dirty surface of the square rod, resulting in a higher cost of auxiliary materials, an increased grinding time, and a raw material loss.

### SUMMARY

In view of the above, according to an embodiment the present disclosure, a sprayer for squaring crystal rod includes a first sprayer for wire guide wheel cleaning and a second sprayer for cutting, the first sprayer for wire guide wheel cleaning is disposed at a side of the wire guide wheel, and a liquid spray direction of the first sprayer for wire guide wheel cleaning corresponds to a wire guide groove of the wire guide wheel, foreign matters in the wire guide groove in a process of squaring the crystal rod are flushed; the second sprayer for cutting is disposed at a side of the crystal rod, and the second sprayer for cutting corresponds to a slit in the process of squaring crystal rod, and sprays the slit to discharge powder.

A silicon rod squaring device includes the sprayer for squaring crystal rod as described above, and the sprayer for squaring crystal rod is disposed inside the squaring device.

### BRIEF DESCRIPTION OF THE DRAWINGS

FIG. 1 is a schematic structural diagram of a sprayer for squaring crystal rod according to an embodiment of the present disclosure.

FIG. 2 is a schematic diagram of a structure of a spray pipe according to an embodiment of the present disclosure.

FIG. 3 is a schematic structural diagram of another structure of a spray pipe according to an embodiment of the present disclosure.

### LIST OF REFERENCE SIGNS

1. First sprayer for wire guide wheel cleaning
2. Second sprayer for cutting
3. Wire guide wheel
4. Crystal rod
20. Spray pipe
200. Spray hole

### DETAILED DESCRIPTION

The present disclosure is described in detail below with reference to the accompanying drawings and some embodiments.

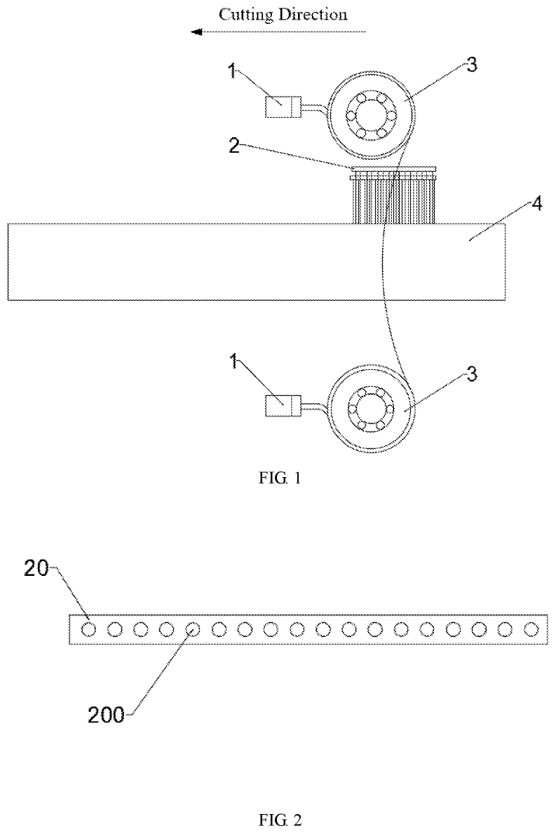

FIG. 1 is a schematic diagram showing a structure according to an embodiment of the present disclosure. The embodiments relate to a sprayer for squaring crystal rod (e.g., monocrystalline silicon rod) and a crystal rod (e.g., monocrystalline silicon rod) squaring device, which are used in the process of squaring a crystal rod. In the process of squaring and cutting of the crystal rod, the sprayer for squaring crystal rod is used to spray a cooling medium on a wire guide wheel and a slit of a crystal rod, respectively. The silicon slag, silicon sludge, and other foreign matters in a wire guide groove of the wire guide wheel are flushed off, and a wire breakage of the apparatus is avoided. The sprayer for squaring crystal rod sprays a cooling medium on a slit at a cutting position to form a point-to-point spray on the slit, so that the silicon powder generated in the slit are effectively discharged, the heat generated by friction between a cutting diamond wire and a crystal rod is reduced, the cutting ability of the cutting diamond wire is improved, and the service life of the diamond wire is prolonged.

As shown in FIG. 1, a sprayer for squaring crystal rod includes a first sprayer for wire guide wheel cleaning 1 and a second sprayer for cutting 2, wherein a liquid spray direction of the first sprayer for wire guide wheel cleaning 1 corresponds to a wire guide groove of the wire guide wheel 3 to flush off foreign matters in the wire guide groove during the process of squaring the crystal rod, a cooling medium sprayed from the first sprayer for wire guide wheel cleaning 1 may be directly sprayed into the wire guide groove of the wire guide wheel 3 to flush off the foreign matters such as silicon slag and silicon sludge in the wire guide groove, so that foreign matters such as silicon slag and silicon sludge in the wire guide wheel 3 may be effectively cleaned, the service life of the wire guide wheel 3 is prolonged, and the occurrence of abnormal wire breakage caused by the foreign matters such as silicon slag and silicon sludge remaining in the wire guide groove is prevented;

The second sprayer for cutting 2 corresponds to the slits in the process of squaring the crystal rod to spray the slits. In the process of squaring the crystal rod, the second sprayer for cutting 2 always corresponds to the slits at the cutting position, so that the cooling medium sprayed from the second sprayer for cutting 2 is kept spraying at the slits to flush off the silicon powder generated at the slits, the generated silicon powder is discharged from the slits, the powder discharge is accelerated, the cutting capacity of the diamond wire is improved, and the temperature of the cut part is lowered, so that the heat generated by friction between the cutting diamond wire and the crystal rod 4 during the cutting process is reduced, and the wire breakage is avoided.

In the cutting and process of squaring the round crystal rod, a diamond wire for cutting is wound on the wire guide wheel 3 and is located in the V-shaped wire guide groove of the wire guide wheel 3. The diamond wire is moved by the rotation of the wire guide wheel 3 to cut and square the crystal rod 4. In the cutting and squaring process, the crystal rod 4 is moved to cut and feed the crystal rod 4. Therefore, foreign matters such as silicon slag and silicon sludge are adhered to the diamond wire in the cutting process, and are deposited in the wire guide groove of the wire guide wheel 3 as the diamond wire moves, thereby causing abnormal wire breakage. Therefore, it is necessary to clean foreign matters such as silicon slag and silicon sludge in the wire guide groove during the squaring and cutting process, so that the diamond wire is not broken due to the foreign matters such as silicon slag and silicon sludge in the wire guide groove during the squaring and cutting process. The first sprayer for wire guide wheel cleaning 1 is used to continuously rinse the wire guide groove to clean the foreign matters such as silicon slag and silicon sludge in the wire guide groove during the squaring process. In the present embodiment, the first sprayer for wire guide wheel cleaning 1 is disposed at a side of the wire guide wheel 3, and the first sprayer for wire guide wheel cleaning 1 is of a pipe structure, so that the cooling medium sprayed from the first sprayer for wire guide wheel cleaning 1 is columnar in shape, has a large flow rate, and has a large impact force when flowing to the wire guide groove, and thus the foreign matters such as silicon slag and silicon sludge in the wire guide groove may be flushed away, thereby maintaining the cleanliness of the wire guide groove of the wire guide wheel 3 during cutting and squaring process, and avoiding the wire breakage.

The first sprayer for wire guide wheel cleaning 1 is installed in the squaring device and is located at a side of the wire guide wheel 3, and the first sprayer for wire guide wheel cleaning 1 is disposed opposite to the wire guide wheel 3, and a liquid outlet of the first sprayer for wire guide wheel cleaning 1 is disposed opposite to the wire guide groove of the wire guide wheel 3 and is located in the same plane as the wire guide groove of the wire guide wheel 3, so that the cooling medium sprayed from the first sprayer for wire guide wheel cleaning 1 is directly sprayed into the wire guide groove, thereby flushing the wire guide groove and the diamond wire located in the wire guide groove.

In the present embodiment, for example, the first sprayer for wire guide wheel cleaning 1 is of a pipe structure, and the cross-sectional shape thereof may be circular, elliptical, polygonal, or the like, which is selected according to actual requirements, and is not specifically limited herein. In order to enable the cooling medium to be sprayed at a certain pressure from the first sprayer for wire guide wheel cleaning 1, the first sprayer for wire guide wheel cleaning 1 has a pipe structure with a variable diameter, in which the diameter of the liquid outlet end is smaller. The size of the first sprayer for wire guide wheel cleaning 1 is selected according to actual requirements, and no specific requirements are set forth herein.

In the present embodiment, for example, the first sprayer for wire guide wheel cleaning 1 is a spray head or a spray pipe, which is a commercially available product, and is selected according to actual requirements, and no specific requirements are set forth herein.

In order to enable the first sprayer for wire guide wheel cleaning 1 to flush away foreign matters such as silicon slag and silicon sludge in the wire guide groove, a spraying route of the cooling medium of the first sprayer for wire guide wheel cleaning 1 may be arranged parallel to the diameter direction of the wire guide wheel 3, or the spraying route of the cooling medium of the first sprayer for wire guide wheel cleaning 1 may be arranged tangentially to the circumference of the wire guide groove. That is, in the plane in which the wire guide wheel 3 and the first sprayer for wire guide wheel cleaning 1 are arranged, the spraying direction of the cooling medium of the first sprayer for wire guide wheel cleaning 1 may be horizontally arranged, parallel to the diameter direction of the wire guide wheel 3, or vertically arranged, parallel to the diameter direction of the wire guide wheel 3, or obliquely arranged, along the tangential direction of the wire guide wheel 3, or alternatively arranged, which may be selectively arranged according to actual requirements, and no specific requirements are set forth herein.

The first sprayer for wire guide wheel cleaning 1 is connected to a cooling medium storage device and a power device. The first sprayer for wire guide wheel cleaning 1 is connected to the power device through a connecting pipe, and the power device is connected to the cooling medium storage device through a connecting pipe. Under the action of the power device, the cooling medium in the cooling medium storage device flows along the connecting pipe and is sprayed from the first sprayer for wire guide wheel cleaning 1. For example, the power device is a pump.

In the crystal rod squaring apparatus, there are a plurality of wire guide wheels 3 wound with the diamond wire to cut and square the round rod. In the plurality of wire guide wheels 3, some wire guide wheels 3 are directly in contact with the diamond wire for the cutting, and foreign matters such as silicon slag and silicon sludge are adhered to the diamond wire and enter the wire guide grooves of the wire guide wheels 3 with the movement of the diamond wire. The other wire guide wheels are in charge of supporting operation of the diamond wire and are not in direct contact with the diamond wire involved in the cutting, and no foreign matters such as silicon slag and silicon sludge enter. Therefore, the wire guide wheel cleaning and sprayer 1 is provided for the wire guide wheels 3 in contact with the diamond wire involved in the cutting. Therefore, the number of the first sprayers for wire guide wheel cleaning 1 is plural, and at least one first sprayer for wire guide wheel cleaning 1 is provided at a side of the wire guide wheel 3 in contact with the diamond wire involved in the cutting. Each of the first sprayers for wire guide wheel cleaning 1 is capable of cleaning a corresponding wire guide wheel 3, so that the wire guide groove of each wire guide wheel 3 is kept clean, and the wire breakage is avoided.

When the plane grinding process is performed, the number of secondary clamping is increased due to the wire breakage, the abnormal grinding is caused by the large gradient difference, which seriously affects the product processing time and the grinding quality of the monocrystal, and the service life of the grinding wheel is greatly reduced. The arrangement of the first sprayer for wire guide wheel cleaning 1 reduces the number of the secondary clamping due to the wire breakage, the gradient of the single crystal processing, and the abnormal grinding line marks, improves the grinding quality, and reduces the production cost.

As shown in FIGS. 1 to 3, the second sprayer for cutting 2 includes at least two spray pipes 20, each of which is located at a side of the crystal rod 4, and the liquid spray direction of each of the plurality of spray pipes 20 corresponds to the slit, so that the cooling medium sprayed from each of the spray pipes 20 is directly sprayed at the slit to flush silicon powder at the slit, and the silicon powder is discharged from the slit under the continuous spraying action of the cooling medium, thereby improving the cutting capacity of the diamond wire, reducing the heat generated by friction between the diamond wire and the crystal rod 4 during the cutting process, reducing the temperature, and prolonging the service life of the diamond wire.

The spray pipe 20 has a tube structure, and the spray pipe 20 has a length selected according to the installation position of the spray pipe 20, the position of the slit, and the length of the slit, which is not specifically limited herein. The spray pipe 20 may have a cross-sectional shape of a circle, an ellipse, or a polygon, or the like, which may be selectively arranged according to actual requirements, and is not specifically limited herein.

The spray pipe 20 is arranged along the axial direction of the crystal rod 4, and a plurality of spray holes 200 are provided on a side of each of the spray pipes 20 facing the crystal rod 4, and the plurality of spray holes 200 are sequentially arranged along the axial direction of the spray pipe 20, so that the cooling medium flowing in the spray pipe 20 may be ejected from each of the spray holes 200, the cooling medium ejected from the spray pipe 20 is ejected to the slit in a water curtain state, the slit is continuously sprayed, and the silicon powder at the slit is discharged efficiently. The arrangement direction of the spray pipe 20 coincides with the feeding direction of the crystal rod 4 in the process of squaring the crystal rod 4. In the squaring and cutting process, since the relative position of the diamond wire and the spray pipe 20 does not change, the spray pipe 20 always corresponds to the cutting position of the diamond wire during the squaring and cutting process, and the spray area of the spray pipe 20 always covers the cutting position of the diamond wire and a portion of the slits at a side of the cutting position, so that the silicon powder on the diamond wire and its vicinity is flushed, thereby effectively discharging the silicon powder.

When the plurality of spray pipes 20 are located on the same plane, the cooling mediums in a water curtain state, which are discharged from respective spray pipes 20, accumulate with each other, and thus the water flow of the cooling medium is increased so as to rinse the slit at the cutting position with a larger water flow, thereby ensuring the discharging of silicon powder from the slit. The plurality of spray pipes 20 located in the same plane may be arranged parallel to the axis of the crystal rod 4, or may be arranged intersecting with the axis of the crystal rod 4. The respective spray pipes 20 may be arranged parallel to each other, or may be arranged intersecting with each other, or some of spray pipes 20 are arranged parallel to each other and some of spray pipes 20 are arranged intersecting with each other, or may be arranged in other ways, which is selected according to the actual needs, but the plurality of spray holes 200 of each spray pipe 20 face the crystal rod 4. For example, in the present embodiment, the plurality of spray pipes 20 are arranged parallel to the axis of the crystal rod 4, and respective spray pipes 20 are arranged parallel to each other.

In the present embodiment, the plurality of spray pipes 20 are arranged in sequence in the direction close to the crystal rod 4, and the plurality of spray pipes 20 are arranged in the plane in which the slits of the crystal rod 4 are located, so that the cooling medium discharged from each of the spray pipes 20 is sprayed to the slits. For example, in the vertical direction, each of two sides of the crystal rod 4 is provided with a wire guide wheel 3, the second sprayer for cutting 2 is arranged above the crystal rod 4, the plurality of spray pipes 20 are arranged in sequence in the direction from the crystal rod 4 to the upper guide wheels, the plurality of spray pipes 20 are arranged in sequence in the vertical direction, and the cooling mediums discharged from the upper spray pipes 20 are sprayed to spray pipes 20 below the upper spray pipes 20, flow in the direction toward the crystal rod 4, are accumulated and sprayed in turn, and are finally sprayed to the slits of the crystal rod 4.

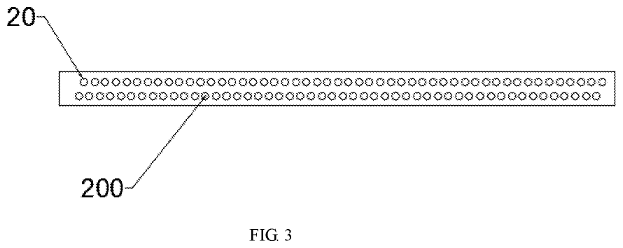

As shown in FIGS. 2 and 3, the plurality of spray holes 200 of each spray pipe 20 may be arranged in at least one row, or may be arranged in one row, or may be arranged in multiple rows, or may be arranged in other ways, and may be selected according to actual requirements, and no specific requirements are set forth herein.

The second sprayer for cutting 2 is connected to a first power device, each spray pipe 20 is connected to the first power device through a connecting pipe, and the first power device is connected to a cooling medium storage device, under the action of the first power device, the cooling medium flows out of the cooling medium storage device and flows along the connecting pipe, and is discharged from the spray holes 200 of each spraying tube 20.

When the plurality of spray pipes 20 are arranged, the distance between the adjacent spray pipes 20 ranges from 2 cm to 5 cm, which is selected according to actual requirements, and is not specifically limited herein.

A silicon rod squaring device includes the above-mentioned device for squaring a round rod, and the device for squaring the crystal rod is fixedly mounted inside the silicon rod squaring device.

In use, the sprayer for squaring the round rod is installed inside the squaring device. Firstly, positions of ones of the plurality of wire guide wheels 3 in the squaring device, which are in direct contact with a diamond wire involved in the cutting, are determined, and then, according to the positions of the guide wheels, the first sprayers for wire guide wheel cleaning 1 are installed. Each of the wire guide wheels 3 in direct contact with the diamond wire involved in the cutting is provided with one first sprayer for wire guide wheel cleaning 1, which is installed on a side of a corresponding wire guide wheel 3 to be cleaned, and the spray direction of the cooling medium of the first sprayer for wire guide wheel cleaning 1 is horizontally provided and is parallel to the diameter of the wire guide wheel 3. The cooling medium is directly sprayed to a wire guide groove of the wire guide wheel 3 in a columnar shape. During rotation of the wire guide wheel 3, the cooling medium is continuously sprayed, so that foreign matters such as silicon slag and silicon sludge in the wire guide groove are flushed away. The second sprayer for cutting 2 is fixedly installed in the squaring device, and the second sprayer for cutting 2 is located on a side of the crystal rod 4. In the direction close to the crystal rod 4, a plurality of spray pipes 20 are sequentially arranged in the plane where the slits are located. The plurality of spray pipes 20 all correspond to the slit positions. The plurality of spray holes 200 on each spray pipe 20 all face the crystal rod 4. During the squaring and cutting process of the crystal rod, the cooling medium discharged from each spray pipe 20 is sprayed to the slit, the cooling medium is continuously sprayed to the slit, and the silicon powder generated at the slit is effectively discharged from the slit, thereby improving the cutting capacity of the diamond wire. At the same time, the cooling medium lowers the temperature of the cutting position, which avoids the breaking of the wire.

According to the above technical solution, the sprayer for squaring crystal rod includes the first sprayer for wire guide wheel cleaning and the second sprayer for cutting, the first sprayer for wire guide wheel cleaning is disposed at a side of any one of wire guide wheels in direct contact with a diamond wire involved in the cutting in the squaring device, the liquid spray direction of the first sprayer for wire guide wheel cleaning corresponds to the wire guide groove of the wire guide wheel, and a cooling medium sprayed by the first sprayer for wire guide wheel cleaning is directly sprayed into the wire guide groove. In the squaring process, the cooling medium is continuously sprayed, and foreign matters such as silicon sludge and silicon slag in the wire guide groove are removed, so that the service life of the wire guide wheel is prolonged, and the occurrence of abnormal wire breakage caused by foreign matters such as silicon sludge and silicon slag remaining in the wire guide groove is prevented. The second sprayer for cutting is disposed at a side of the crystal rod, and the second sprayer for cutting corresponds to the cutting slit at the cutting position. In a squaring process, the second sprayer for cutting continues to spray the cutting slit, so that silicon powder at the cutting slit is discharged. The second sprayer for cutting is provided with a plurality of spray pipes, the cooling medium flow is increased, the powder discharging is accelerated, and thus the cutting capacity of the diamond wire is improved. Meanwhile, the heat generated by friction between the diamond wire and the crystal rod at the cutting position is cooled, and the service life of the diamond wire is prolonged. The second sprayer for cutting sprays the cutting slit at the cutting position to form point-to-point targeted spraying, so that the wire break is avoided, the number of the secondary clamping due to the wire break is reduced, the monocrystalline processing gradient is reduced, the abnormal generation of the grinding line marks is reduced, the grinding quality is increased, and the production cost is reduced.

Some embodiments of the present disclosure have been described in detail above, but should not be considered as limiting the scope of the present disclosure. All equivalents and modifications made in accordance with the present disclosure shall still fall within the scope of the present disclosure.

What is claimed is:

1. A sprayer for squaring a crystal rod, comprising one or more first sprayers for wire guide wheel cleaning and a second sprayer for cutting,
wherein each of the first sprayers for wire guide wheel cleaning is disposed at a side of a wire guide wheel and has a liquid spray direction corresponding to a wire guide groove of the wire guide wheel for flushing foreign matters in the wire guide groove in a process of squaring the crystal rod; and
wherein the second sprayer for cutting is disposed at a side of the crystal rod and corresponds to a slit in the process of squaring the crystal rod to spray the slit and discharge powder.

2. The sprayer according to claim 1, wherein the second sprayer for cutting comprises at least two spray pipes located at the side of the crystal rod and each having a liquid spray direction corresponding to the slit.

3. The sprayer according to claim 2, wherein the at least two spray pipes are located in a same plane.

4. The sprayer according to claim 3, wherein each of the at least two spray pipes is arranged parallel to an axis of the crystal rod.

5. The sprayer according to claim 2, wherein the at least two spray pipes are arranged in sequence in a direction close to the crystal rod, and the at least two spray pipes are arranged in a plane in which slits of the crystal rod are located.

6. The sprayer according to claim 5, wherein a distance between adjacent spray pipes of the at least two spray pipes ranges from 2 cm to 5 cm.

7. The sprayer according to claim 2, wherein a plurality of spray holes are provided on a side of any one spray pipe of the at least two spray pipes facing the crystal rod, and the plurality of spray holes are sequentially arranged in a row along an axial direction of the any one spray pipe.

8. The sprayer according to claim 1, wherein the one or more first sprayers for wire guide wheel cleaning comprise a plurality of first sprayers for wire guide wheel cleaning, at least one first sprayer for wire guide wheel cleaning of the plurality of first sprayers for wire guide wheel cleaning is disposed at a side of any one wire guide wheel in contact with a diamond wire involved in a cutting process, and each of the plurality of first sprayers for wire guide wheel cleaning has a pipe structure.

9. The sprayer according to claim 8, wherein the liquid spray direction of each of the plurality of first sprayers for wire guide wheel cleaning is parallel to a diameter direction of the wire guide wheel.

10. The sprayer according to claim 8, wherein the liquid spray direction of each of the plurality of first sprayers for wire guide wheel cleaning intersect a diameter direction of the wire guide wheel.

11. A crystal rod squaring device comprising the sprayer for squaring the crystal rod according to claim 1 disposed inside the crystal rod squaring device.
